(19) United States
(12) Patent Application Publication
(10) Pub. No.: US 2024/0355182 A1
(43) Pub. Date: Oct. 24, 2024

(54) INFORMATION PROCESSOR AND INFORMATION PROCESSING METHOD

(71) Applicant: SONY GROUP CORPORATION, TOKYO (JP)

(72) Inventors: TAKAYOSHI TAKAYANAGI, TOKYO (JP); HIROTAKA SUZUKI, TOKYO (JP); YU ISHIHARA, TOKYO (JP); TOMOKO KATSUHARA, TOKYO (JP)

(21) Appl. No.: 18/575,416

(22) PCT Filed: Feb. 25, 2022
(86) PCT No.: PCT/JP2022/008065

§ 371 Date: Dec. 29, 2023

(30) Foreign Application Priority Data
Jul. 13, 2021 (JP) 2021-115815

(51) Int. Cl. G08B 6/00

(52) U.S. Cl. CPC G08B 6/00

(57) ABSTRACT

An information processor according to the present disclosure includes a deviation amount predictor that predicts, on the basis of a first sensor value acquired by bringing a tactile sensor into contact with a connector and a second sensor value acquired by bringing the tactile sensor into contact with a first candidate location of an insertion target for the connector, a positional deviation amount between the connector and the insertion target.

### TECHNICAL FIELD

The present disclosure relates to an information processor and an information processing method.

### BACKGROUND ART

For example, there is a technique of inserting a connector gripped by a robot into an insertion target (for example, see PTLs 1 to 2).

### CITATION LIST

### Patent Literature

PTL 1: Japanese Unexamined Patent Application Publication No. 2020-49581
PTL 2: Japanese Unexamined Patent Application Publication No. 2016-59971

### SUMMARY OF THE INVENTION

To properly insert a connector into an insertion target, it is desirable to properly recognize positions of the connector and the insertion target.

It is desirable to provide an information processor and an information processing method that make it possible to properly perform insertion of a connector.

An information processor according to an embodiment of the present disclosure includes a deviation amount predictor that predicts, on the basis of a first sensor value acquired by bringing a tactile sensor into contact with a connector and a second sensor value acquired by bringing the tactile sensor into contact with a first candidate location of an insertion target for the connector, a positional deviation amount between the connector and the insertion target.

An information processing method according to the one embodiment of the present disclosure includes: acquiring a first sensor value by bringing a tactile sensor into contact with a connector; acquiring a second sensor value by bringing the tactile sensor into contact with a first candidate location of an insertion target for the connector; and predicting a positional deviation amount between the connector and the insertion target on the basis of the first sensor value and the second sensor value.

In the information processor or the information processing method according to the one embodiment of the present disclosure, it is predicted, on the basis of a first sensor value acquired by bringing a tactile sensor into contact with a connector and a second sensor value acquired by bringing the tactile sensor into contact with a first candidate location of an insertion target for the connector, a positional deviation amount between the connector and the insertion target.

### BRIEF DESCRIPTION OF DRAWING

FIG. 1 is a configuration diagram illustrating an outline of a connector insertion system according to a first embodiment of the present disclosure.

FIG. 2 is a block diagram schematically illustrating a configuration example of an information processor according to the first embodiment.

FIG. 3 is a flowchart illustrating an example of operation of the connector insertion system according to the first embodiment.

FIG. 4 is an explanatory diagram schematically illustrating an example of operation of bringing a tactile sensor into re-contact with a receptacle on the basis of a result of detection performed by a receptacle detector.

FIG. 5 is an explanatory diagram schematically illustrating an example of data collection performed by the receptacle detector.

FIG. 6 is a flowchart illustrating an operation example of the data collection performed by the receptacle detector.

FIG. 7 is a configuration diagram schematically illustrating an example of learning performed by the receptacle detector.

FIG. 8 is a configuration diagram schematically illustrating an example of learning performed by a deviation amount predictor.

### MODES FOR CARRYING OUT THE INVENTION

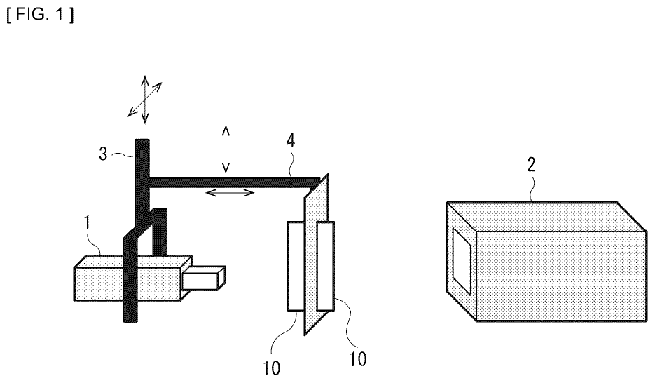

In the following, an embodiment of the present disclosure will be described in detail with reference to the drawings. It is to be noted that the description will be given in the following order.
1. First Embodiment (FIGS. 1 to 8)
   1.0 Outline
   1.1 Configuration
   1.2 Operation
   1.3 Effects
2. Other embodiments

### 1. First Embodiment

### [1.0 Outline]

In general, an insertion task of an object such as a connector by a robot is performed while properly recognizing positions and postures of the object such as the connector being gripped (a gripped object) and an object serving as an insertion target. To recognize positions and postures of a gripped object and an object serving as an insertion target, an image captured by a camera is used in many cases. However, in a dark place and a place where an object to be captured is hidden by another object, where it is difficult to capture an image by a camera, for example, an image captured in such a place does not include information regarding a gripped object and an object serving as an insertion target, making it difficult to properly recognize their positions and postures.

Then, the technique of the present disclosure addresses use of a tactile sensor to recognize a position and a posture of an object serving as an insertion target. It is considered that, if it is possible to use and bring a tactile sensor into contact with a location that is difficult to capture an image by a camera, it is possible to recognize a position and a posture of the portion on the basis of a state of the tactile sensor.

Furthermore, in a task called connector insertion, it is possible to assume that a shape of a connector desired to be inserted and a shape of a location into which the connector is to be inserted (a receptacle) correspond to each other in a one-by-one manner. Therefore, even in a case where there is a plurality of candidate locations, into one of which a connector is to be inserted, it is possible to estimate a receptacle into which the connector should be inserted on the basis of a value of the tactile sensor, which is acquired as the tactile sensor is brought into contact with the connector. As a situation where there is a plurality of candidate locations into one of which a connector is to be inserted, for example, one possible situation is that there is a plurality of receptacles including, for example, a high-definition multimedia interface (HDMI) (registered trade mark) and a universal serial bus (USB).

In the technique of the present disclosure, a location of a receptacle into which a connector should be inserted is detected from a value of the tactile sensor, which is acquired as the tactile sensor is brought into contact with the connector, and a value of the tactile sensor, which is acquired as the tactile sensor is brought into contact with a location around the receptacle. It is then estimated how much the connector and the receptacle are deviated from each other on the basis of a result of the detection.

Note that PTL 1 (Japanese Unexamined Patent Application Publication No. 2020-49581) proposes a technique of attaching a tactile sensor to an end effector that grips a connector. In the technique described in PTL 1, a deviation in position and posture of the gripped object is recognized on the basis of a value of the tactile sensor. A deviation amount is then corrected. Thereafter, insertion operation is started. Although PTL 1 proposes a technique of correcting a deviation in position and a deviation in posture of a gripped object from information regarding the tactile sensor, the technique addresses neither how to recognize a position and a posture of a target object that is desired to be inserted into the gripped object nor how to correct a deviation in position between the gripped object and the target object that is desired to be inserted into the gripped object.

PTL 2 (Japanese Unexamined Patent Application Publication No. 2016-59971) proposes a technique of performing a fitting task using force sensors attached to an arm and a hand. It is estimated, from values of the force sensors, whether or not a connector and a receptacle have collided with each other as the connector and the receptacle are fitted with each other. In a case where the connector and the receptacle have collided with each other, it is estimated that how much the connector and the receptacle should be moved relative to each other to make it possible to properly fit the connector and the receptacle with each other. PTL 2 does not however disclose such a technique that uses a tactile sensor. Furthermore, it does not support a case where there is a plurality of candidate locations of insertion.

### [1.1 Configuration]

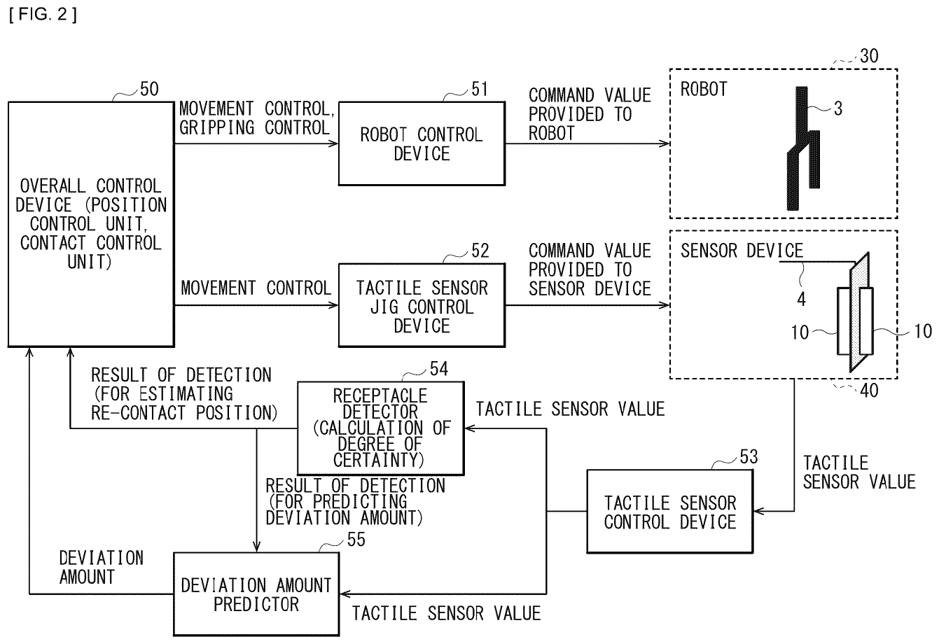

FIG. 1 illustrates an outline of a connector insertion system according to a first embodiment of the present disclosure. FIG. 2 schematically illustrates a configuration example of an information processor according to the first embodiment, which is applied to the connector insertion system.

The connector insertion system according to the first embodiment is a system where a hand 3 of a robot 30 grips a connector 1 serving as a gripped object and inserts the connector 1 into a receptacle 2 serving as an insertion target.

The robot 30 is able to cause the hand 3 to move a position of the connector 1 to any given position. There may be a plurality of candidate insertion targets for the connector 1.

As a preliminary stage before inserting the connector 1 into the receptacle 2 in the connector insertion system, a tactile sensor 10 is disposed between the connector 1 and the receptacle 2. It is possible to cause a tactile sensor jig 4 to move the tactile sensor 10 to any given position. In a stage of actually inserting the connector 1 into the receptacle 2, the tactile sensor 10 is moved to a position that differs from the position between the connector 1 and the receptacle 2.

The connector insertion system includes, for example, such an information processor as illustrated in FIG. 2. The information processor according to the first embodiment includes an overall control device 50, a robot control device 51, a tactile sensor jig control device 52, a tactile sensor control device 53, a receptacle detector 54, and a deviation amount predictor 55.

The overall control device 50 corresponds to a specific example of a “position control unit” and a “contact control unit” in the technique of the present disclosure. The receptacle detector 54 corresponds to a specific example of an “insertion target detector” in the technique of the present disclosure.

The robot control device 51 generates a command value provided to the robot 30 on the basis of a control value regarding movement control and gripping control, for example, which is provided from the overall control device 50, to control a gripping state of the connector 1 by the hand 3 of the robot 30 and a position of the connector 1 being gripped, for example.

The tactile sensor jig control device 52 generates a command value provided to a sensor device 40 on the basis of a control value regarding movement control, for example, which is provided from the overall control device 50, to control a position of the tactile sensor 10 by the tactile sensor jig 4 in the sensor device 40, for example.

The tactile sensor control device 53 outputs a tactile sensor value acquired from the tactile sensor 10 in the sensor device 40 to the receptacle detector 54 and the deviation amount predictor 55. The tactile sensor control device 53 acquires, as tactile sensor values, a first sensor value acquired by bringing the tactile sensor 10 into contact with the connector 1 and a second sensor value acquired by bringing the tactile sensor 10 into contact with a first candidate location of an insertion target for the connector 1.

The deviation amount predictor 55 predicts, on the basis of the first sensor value acquired by bringing the tactile sensor 10 into contact with the connector 1 and the second sensor value acquired by bringing the tactile sensor 10 into contact with the first candidate location of the insertion target for the connector 1, a positional deviation amount between the connector 1 and the receptacle 2 serving as the insertion target.

The receptacle detector 54 detects a region corresponding to the connector 1 in the first candidate location described above on the basis of the first sensor value and the second sensor value described above to calculate a degree of certainty as to with what degree of probability the region corresponding to the connector 1 corresponds to the connector 1. Furthermore, the receptacle detector 54 detects, in a case where there is a plurality of regions corresponding to the connector 1, a region where the degree of certainty is highest among the plurality of regions, as the receptacle 2 serving as the insertion target for the connector 1.

The overall control device 50 controls each of the components of the connector insertion system. The overall control device 50 may be a computer including, for example, a central processing unit (CPU), a read only memory (ROM), and a random access memory (RAM). In this case, various types of processing performed by the overall control device 50 may be achieved by the CPU executing processing based on programs stored in the ROM or the RAM. Furthermore, various types of processing performed by the overall control device 50 may be achieved, for example, by the CPU executing processing based on programs externally supplied via a wired or wireless network.

The overall control device 50 takes a role as a position control unit that corrects a position of the connector 1 on the basis of a positional deviation amount predicted by the deviation amount predictor 55. The overall control device 50 outputs a control value to the robot control device 51 to cause the robot 30 gripping the connector 1 to correct the position of the connector 1.

Furthermore, the overall control device 50 takes a role as a contact control unit that brings the tactile sensor 10 into re-contact with a second candidate location, which differs from the first candidate location, of the receptacle 2 in a case where a degree of certainty calculated by the receptacle detector 54 is lower than a first threshold value.

The overall control device 50 determines the second candidate location of the receptacle 2 on the basis of the degree of certainty in a case where the degree of certainty is lower than the first threshold value and is higher than a second threshold value.

The overall control device 50 designates any given region that differs from the first candidate location as the second candidate location on the receptacle 2 in a case where the degree of certainty is lower than the first threshold value and is lower than the second threshold value.

### [1.2 Operation]

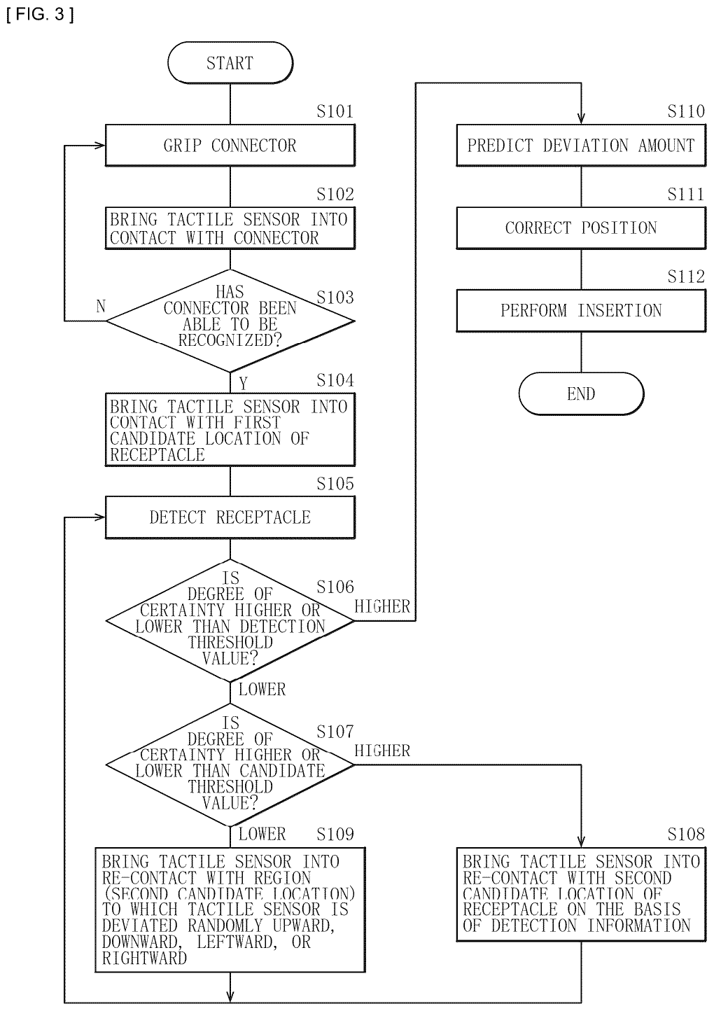

FIG. 3 is a flowchart illustrating an example of operation of the connector insertion system according to the first embodiment.

The robot 30 first causes the hand 3 to grip the connector 1 serving as an object to be inserted into the receptacle 2 (step S101). Next, the tactile sensor jig 4 brings the tactile sensor 10 into contact with the gripped object (the connector 1) (step S102). Next, the tactile sensor control device 53 determines whether or not it has been able to recognize the connector 1 serving as the gripped object (step S103). In a case where the tactile sensor control device 53 determines that it has not yet been able to recognize the gripped object (step S103; N), the robot 30 again performs gripping operation (step S101).

On the other hand, in a case where the tactile sensor control device 53 determines that it has been able to recognize the gripped object (step S103; Y), the tactile sensor jig 4 then brings the tactile sensor 10 into contact with a candidate location (a first candidate location) of the insertion target (the receptacle 2) (step S104). Next, the tactile sensor control device 53 inputs, into the receptacle detector 54, a tactile sensor value (a first sensor value) acquired as the tactile sensor 10 is brought into contact with the connector 1 and a tactile sensor value (a second sensor value) acquired as the tactile sensor 10 is brought into contact with the first candidate location of the receptacle 2. The receptacle detector 54 detects a region on the receptacle 2, which corresponds to the connector 1 (step S105). Furthermore, the receptacle detector 54 further outputs a degree of certainty as to with what degree of probability the region on the receptacle 2 corresponds to the connector 1. Next, the receptacle detector 54 determines whether or not the degree of certainty is higher than a first threshold value (also referred to as a detection threshold value) (step S106).

In a case where the receptacle detector 54 determines that the degree of certainty is higher than the detection threshold value, the deviation amount predictor 55 then predicts a deviation amount that should be corrected on the basis of the tactile sensor value acquired as the connector 1 is brought into contact with the receptacle 2 and information regarding the region from which the receptacle 2 is detected (for example, information indicating a position and a size of a region corresponding to a location of the receptacle 2) (step S110). Finally, position correction is performed on the basis of the predicted deviation amount on a side of the robot 30 (step S111), and the robot 30 performs insertion operation for the connector 1 (step S112).

Furthermore, in a case where the receptacle detector 54 determines that the degree of certainty is lower than the detection threshold value, the connector insertion system again enters a phase of bringing the tactile sensor 10 into contact with the receptacle 2. The overall control device 50 determines a location of re-contact on the basis of the degree of certainty. Therefore, the overall control device 50 first determines whether or not the degree of certainty is higher than another threshold value, i.e., a second threshold value (also referred to as a candidate threshold value), than the detection threshold value (step S107). Note that the second threshold value is a threshold value that is set lower than the first threshold value (the first threshold value>the second threshold value).

In a case where it is determined that the degree of certainty is higher than the candidate threshold value, the overall control device 50 then regards the case as a situation where the corresponding receptacle 2 is partially in contact with the tactile sensor 10, controls the tactile sensor jig control device 52 on the basis of detection information regarding the tactile sensor 10, and brings the tactile sensor 10 into re-contact with a portion at a position (a second candidate location) moved in a direction toward the portion with which the receptacle 2 has come into contact, relative to a first candidate region on (the first candidate location of) the receptacle 2 (step S108).

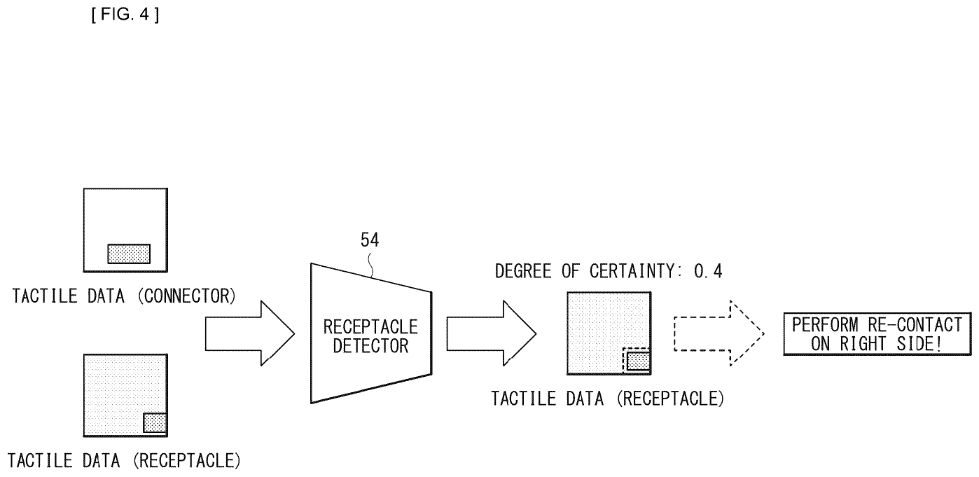

FIG. 4 schematically illustrates an example of operation of bringing the tactile sensor 10 into re-contact with the receptacle 2 on the basis of a result of detection performed by the receptacle detector 54. In a case where it is conceivable that the receptacle 2 is present at a rightward position, as illustrated in FIG. 4, for example, the tactile sensor 10 is brought into re-contact with a location of the receptacle 2, which is present at a rightward-shifted position. Next, the connector insertion system again starts operation of causing the receptacle detector 54 to detect a region on the receptacle 2 (step S105). Thereafter, in a case where the receptacle detector 54 determines that the degree of certainty becomes higher than the detection threshold value, the deviation amount predictor 55 predicts a deviation amount that should be corrected (step S110). Finally, position correction is performed on the basis of the predicted deviation amount on the side of the robot 30 (step S111), and the robot 30 performs insertion operation for the connector 1 (step S112).

Since a case where it is determined that the degree of certainty is lower than the candidate threshold value is regarded as a situation where a region where the receptacle 2 is present is not estimated, the overall control device 50 controls the tactile sensor jig control device 52 to bring the tactile sensor 10 into re-contact with any given region (a second candidate location), which differs from the first candidate region (the first candidate location), on the receptacle 2. For example, the tactile sensor 10 is brought into re-contact with a region (a second candidate location), which is deviated randomly upward, downward, leftward, or rightward relative to the first candidate region (the first candidate location), on the receptacle 2 (step S109). Next, operation of causing the receptacle detector 54 to detect a region on the receptacle 2 is started again (step S105). Thereafter, in a case where the receptacle detector 54 determines that the degree of certainty becomes higher than the detection threshold value, the deviation amount predictor 55 predicts a deviation amount that should be corrected (step S110). Finally, position correction is performed on the basis of the predicted deviation amount on the side of the robot 30 (step S111), and the robot 30 performs insertion operation for the connector 1 (step S112).

Next, how to acquire the receptacle detector 54 through learning will now be described herein. A process of acquiring the receptacle detector 54 is divided into two phases that are “data collection” and “learning”. The phases will now be described in order.

### (Data Collection)

In the phase of data collection, the tactile sensor 10, and the connector 1 and the receptacle 2 serving as targets to be detected, are actually used to collect data necessary for performing learning. Although those relating to the connector 1 will be described herein as an example, the same applies to those relating to the receptacle 2.

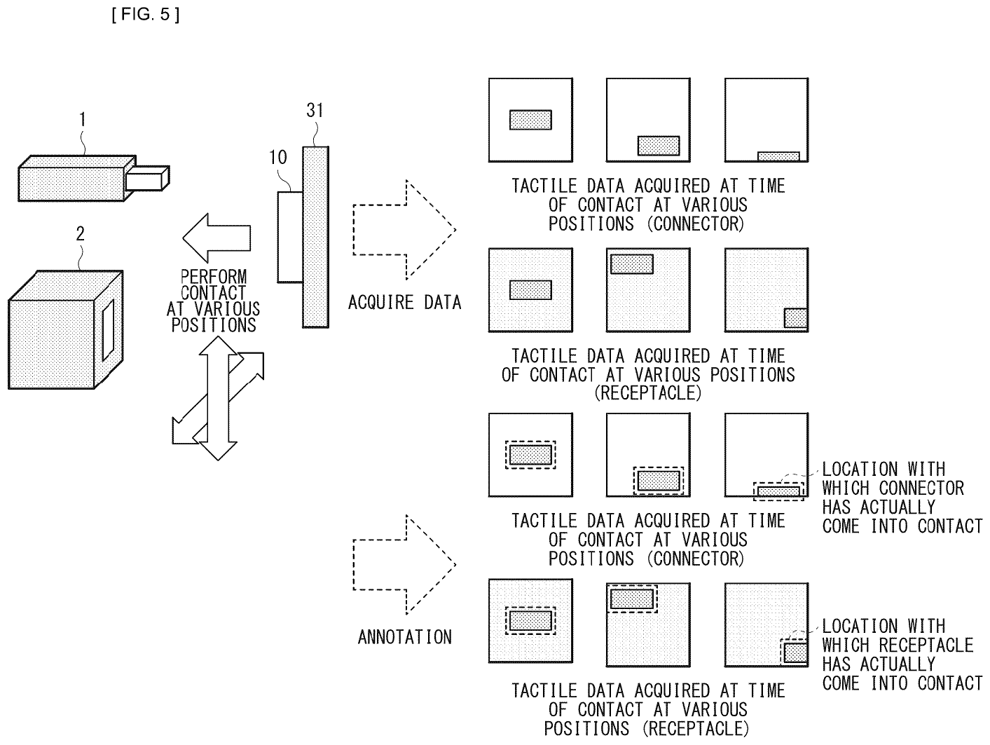

FIG. 5 schematically illustrates an example of data collection performed by the receptacle detector 54.

In performing data collection, for example, the tactile sensor 10 is brought into contact at various positions to acquire a plurality of pieces of tactile data. As the robot 30 attached with the tactile sensor 10 moves a certain amount, and the tactile sensor 10 is brought into contact with the connector 1, it is possible to acquire a piece of tactile data at the time when the tactile sensor 10 is moved at the certain amount from a reference position. By repeating such a maneuver, it is possible to acquire a plurality of the pieces of tactile data at the time when the tactile sensor 10 is brought into contact at the various positions of the connector 1. The tactile sensor 10 is disposed on a surface of a plate 31 attached to the robot 30, for example. After the pieces of data have been acquired, an annotation (additional information) indicating a portion of the pieces of tactile data, which corresponds to the connector 1, is provided. As an annotation, for example, information regarding a position, a width, and a height of an actual region corresponding to the connector 1 is provided. It is possible to provide all annotations manually. However, in a case where an amount of movement of the tactile sensor 10 and an amount of movement that a tactile sensor value indicates have been calibrated (for example, in a case where the tactile sensor 10 is moved laterally by 5 mm, a piece of tactile data indicates a lateral movement of 5 mm), it is possible to provide an annotation to a piece of data on the reference position only, and it is possible to automatically provide an annotation to another piece of data on the basis of the calibration information. Furthermore, the data collection may be performed on another connector 1.

The receptacle detector 54 may perform, as described above, learning for detecting a region corresponding to the connector 1, as will be described later, on the basis of a plurality of pieces of tactile data on the connector 1, which is acquired by bringing the tactile sensor 10 into contact with the connector 1 at a plurality of positions in advance, and a plurality of pieces of tactile data on the receptacle 2, which is acquired by bringing the tactile sensor 10 into contact with the receptacle 2 at a plurality of positions in advance. In this case, each of the plurality of pieces of tactile data on the connector 1 may be provided with an annotation regarding a location with which the connector 1 has actually come into contact, and each of the plurality of pieces of tactile data on the receptacle 2 may be provided with an annotation regarding a location with which the receptacle 2 has actually come into contact.

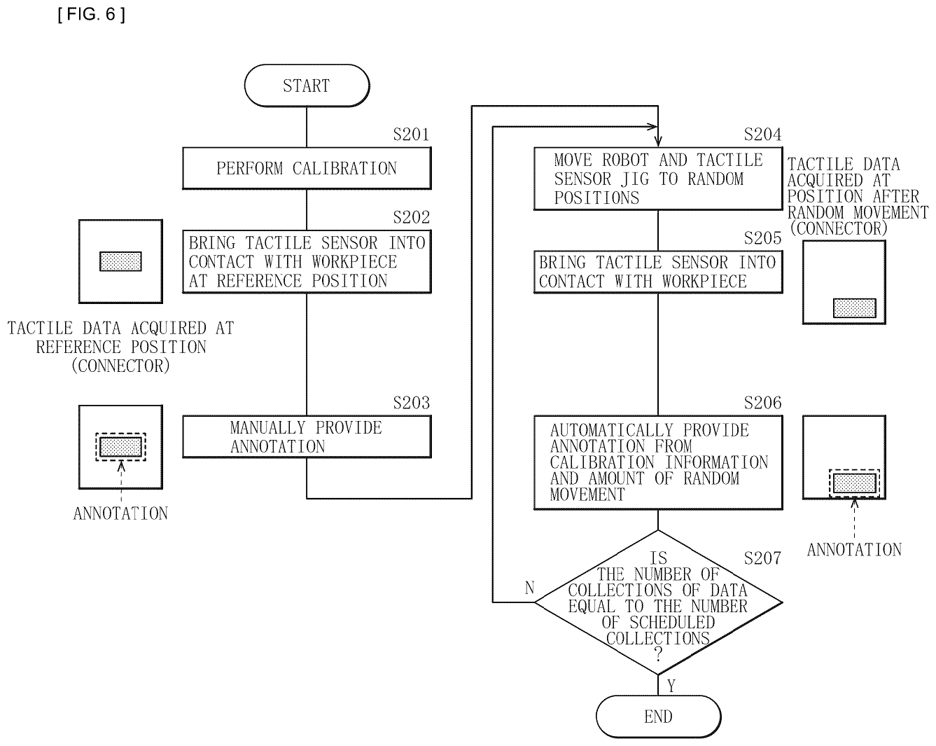

FIG. 6 is a flowchart illustrating an operation example of the data collection performed by the receptacle detector 54. Note that, although FIG. 6 illustrates an example of a piece of tactile data acquired as the tactile sensor 10 is brought into contact with the connector 1, the same applies to a piece of tactile data acquired as the tactile sensor 10 is brought into contact with the receptacle 2.

In the connector insertion system, an amount of movement of the robot 30 (an amount of movement of the tactile sensor 10) and an amount of movement that a piece of tactile data indicates are first calibrated (step S201). For example, it is estimated that, as the robot 30 moves 1 mm, a number of nodes to which the movement corresponds, as a piece of tactile data (a tactile sensor value). Next, in the connector insertion system, the tactile sensor 10 is brought into contact with a workpiece at the reference position (step S202). Note herein that the workpiece may include both the connector 1 and the receptacle 2.

Next, an annotation is provided manually to a piece of tactile data acquired as there has been contact caused to occur at the reference position (step S203). Next, in the connector insertion system, the robot 30 and the tactile sensor jig 4 are moved to random positions (step S204). Next, in the connector insertion system, the tactile sensor 10 is brought into contact with the workpiece (step S205).

Next, in the connector insertion system, an annotation is automatically provided from calibration information and an amount of the random movement (step S206). Next, in the connector insertion system, it is determined whether or not a number of collections of data is equal to the number of scheduled collections (step S207). In a case where it is determined that the number of collections of data is not equal to the number of scheduled collections (the number of collections of data has not yet reached the scheduled number of collection) (step S207; N), the connector insertion system causes the processing to return to step S204. On the other hand, in a case where it is determined that the number of collections of data is equal to the number of scheduled collections (step S207; Y), the connector insertion system causes the processing of the data collection to end.

### (Learning of Receptacle Detector 54)

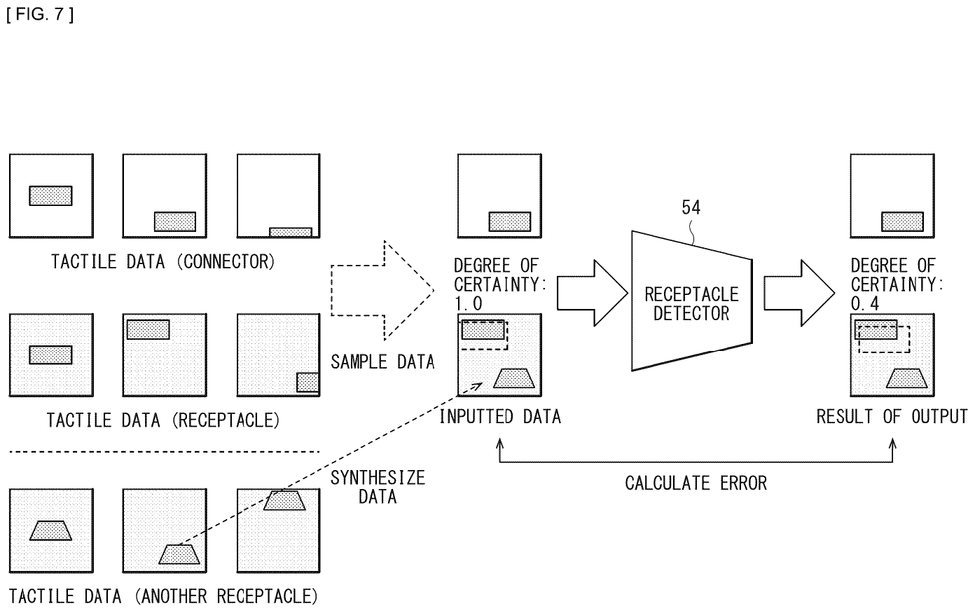

FIG. 7 schematically illustrates an example of learning performed by the receptacle detector 54.

The pieces of data collected in the phase of the data collection described above are used to enter a phase of performing learning for the receptacle detector 54. FIG. 7 illustrates an outline. What the receptacle detector 54 outputs are a location where the receptacle 2 corresponding to the connector 1 is present and a degree of certainty at which the receptacle 2 is present.

A flow in a case where learning is performed will now be described herein. Pieces of data are first randomly sampled from the collected pieces of data. At that time, as to a tactile sensor value acquired as there is contact with the receptacle 2, a tactile sensor value acquired as there is contact with another receptacle 2 corresponding to another connector 1 is sampled simultaneously, and synthesized data is generated. Thereby, even in a case where another type of a receptacle 2 is included, it is possible to perform learning to make it possible to detect only the receptacle 2 corresponding to the connector 1. Sampled data is inputted into the receptacle detector 54. An outputted result and correct data are compared with each other to calculate an error to update the receptacle detector 54. These tasks are repeated.

### (Learning of Deviation Amount Predictor 55)

Next, how to acquire the deviation amount predictor 55 through learning will now be described herein. A process of acquiring the deviation amount predictor 55 is divided into two phases that are “data collection” and “learning”. Since the phase of “data collection” takes place simultaneously with the phase of “data collection” for acquiring the receptacle detector 54, as described above, the phase of “learning” will only be described herein.

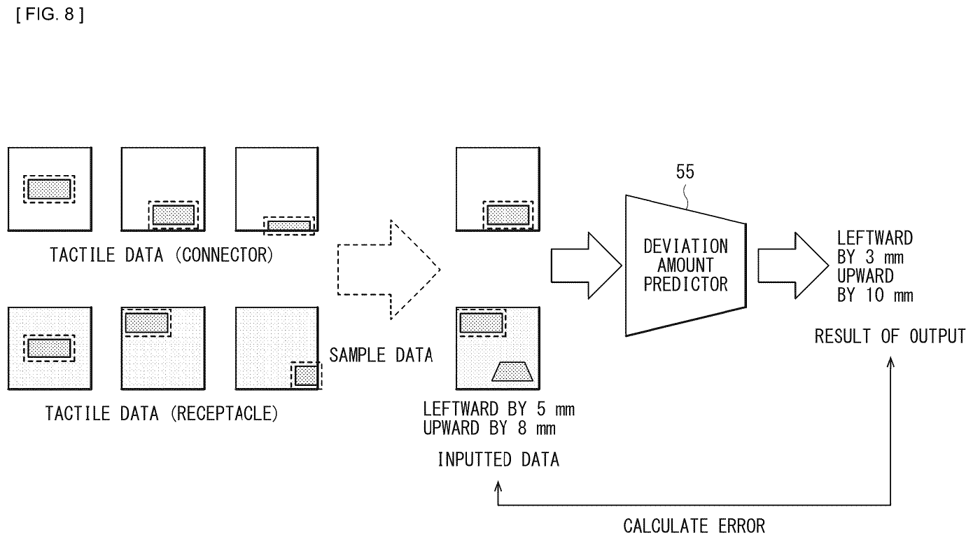

FIG. 8 schematically illustrates an example of learning performed by the deviation amount predictor 55.

The deviation amount predictor 55 performs learning for predicting a positional deviation amount on the basis of, for example, a plurality of pieces of tactile data on the connector 1, which is acquired by bringing the tactile sensor 10 into contact with the connector 1 at a plurality of positions in advance, and a plurality of pieces of tactile data on the receptacle 2, which is acquired by bringing the tactile sensor 10 into contact with the receptacle 2 at a plurality of positions in advance.

What the deviation amount predictor 55 outputs is an amount of movement necessary for correcting a positional deviation between the connector 1 and the receptacle 2 serving as an insertion target. A flow in a case where learning is performed will now be described herein. Pieces of data are first randomly sampled from the collected pieces of data. The sampled data is inputted into the deviation amount predictor 55 to output a result of prediction for a positional deviation amount. Correct data corresponding to the sampled data and a result of the output are compared with each other to calculate an error to update the deviation amount predictor 55.

Note that, as to the deviation amount predictor 55, there is another idea of using a connector detector as an alternative. The connector 1 is first detected from a tactile sensor value acquired as there is contact with the connector 1. Next, detection is performed by the receptacle detector 54 as described above. Finally, a positional deviation amount is calculated from a position of the detected connector 1 and a position of the receptacle 2.

### [1.3 Effects]

In the information processor and the information processing method according to the first embodiment, as described above, it is predicted, on the basis of a first sensor value acquired by bringing the tactile sensor 10 into contact with the connector 1 and a second sensor value acquired by bringing the tactile sensor 10 into contact with a first candidate location of an insertion target for the connector 1, a positional deviation amount between the connector 1 and the insertion target. A positional deviation between the connector 1 and the insertion target is then corrected on the basis of the predicted positional deviation amount. Thereby, it is possible to properly perform insertion of the connector 1.

Furthermore, with the information processor and the information processing method according to the first embodiment, it is possible to select a proper receptacle 2 even in a case where there are receptacles 2 corresponding to a plurality of types of connectors 1 serving as insertion targets. In a case where there is a plurality of receptacles 2 corresponding to a connector 1, insertion into a location where a degree of certainty of detection is higher is performed, making it possible to further properly perform insertion of the connector 1.

Furthermore, with the information processor and the information processing method according to the first embodiment, the tactile sensor 10 is brought into re-contact with the receptacle 2 on the basis of a degree of certainty of detection even in a case where a portion of the receptacle 2 is not present within a range where there is contact by the tactile sensor 10 in a case where the receptacle 2 corresponding to the connector 1 is to be detected. Thereby, it is possible to further securely perform prediction of a positional deviation amount and correction of a positional deviation.

Note that the effects described in the specification are mere examples. The effects of the technique are not limited to the effects described in the specification. There may be any other effects than those described herein. The same applies to effects of other embodiments described below.

### 2. Other Embodiments

The technique according to the present disclosure is not limited to the embodiment described above. It is possible to modify and implement the technique according to the present disclosure in a wide variety of ways.

For example, the present technique may have the following configurations.

According to the present technique having configurations described below, is predicted, on the basis of a first sensor value acquired by bringing a tactile sensor into contact with a connector and a second sensor value acquired by bringing the tactile sensor into contact with a first candidate location of an insertion target for the connector, a positional deviation amount between the connector and the insertion target.

Thereby, it is possible to properly perform insertion of the connector.

(1)

An information processor including a deviation amount predictor that predicts, on the basis of a first sensor value acquired by bringing a tactile sensor into contact with a connector and a second sensor value acquired by bringing the tactile sensor into contact with a first candidate location of an insertion target for the connector, a positional deviation amount between the connector and the insertion target.

(2)

The information processor according to (1), further including a position control unit that corrects a position of the connector on the basis of the positional deviation amount predicted by the deviation amount predictor.

(3)

The information processor according to (2), in which the position control unit causes a robot gripping the connector to correct the position of the connector.

(4)

The information processor according to any one of (1) to (3), further including an insertion target detector that detects a region corresponding to the connector in the first candidate location on the basis of the first sensor value and the second sensor value to calculate a degree of certainty as to with what degree of probability the region corresponding to the connector corresponds to the connector.

(5)

The information processor according to (4), further including a contact control unit that brings the tactile sensor into re-contact with a second candidate location that differs from the first candidate location in a case where the degree of certainty calculated by the insertion target detector is lower than a first threshold value.

(6)

The information processor according to (5), in which the contact control unit determines the second candidate location on the basis of the degree of certainty in a case where the degree of certainty is lower than the first threshold value and is higher than a second threshold value.

(7)

The information processor according to (5) or (6), in which the contact control unit designates any given region that differs from the first candidate location as the second candidate location in a case where the degree of certainty is lower than the first threshold value and is lower than the second threshold value.

(8)

The information processor according to any one of (4) to (7), in which the insertion target detector detects, in a case where there is a plurality of regions corresponding to the connector, a region where the degree of certainty is highest among the plurality of regions, as the insertion target for the connector.

(9)

The information processor according to any one of (4) to (8), in which the insertion target detector performs learning for detecting the region corresponding to the connector on the basis of tactile data on the connector and tactile data on the insertion target, the tactile data on the connector being acquired by bringing the tactile sensor into contact with the connector at a reference position in advance, the tactile data on the insertion target being acquired by bringing the tactile sensor into contact with the insertion target at the reference position in advance.

(10)

The information processor according to any one of (4) to (8), in which the insertion target detector performs learning for detecting the region corresponding to the connector on the basis of a plurality of pieces of tactile data on the connector and a plurality of pieces of tactile data on the insertion target, the plurality of pieces of tactile data on the connector being acquired by bringing the tactile sensor into contact with the connector at a plurality of positions in advance, the plurality of pieces of tactile data on the insertion target being acquired by bringing the tactile sensor into contact with the insertion target at the plurality of positions in advance.

(11)

The information processor according to (10), in which
the plurality of pieces of tactile data on the connector is each provided with additional information regarding a location with which the connector has actually come into contact, and
the plurality of pieces of tactile data on the insertion target is each provided with additional information regarding a location with which the insertion target has actually come into contact.
   (12)

The information processor according to any one of (1) to (11), in which the deviation amount predictor performs learning for predicting the positional deviation amount on the basis of a plurality of pieces of tactile data on the connector and a plurality of pieces of tactile data on the insertion target, the plurality of pieces of tactile data on the connector being acquired by bringing the tactile sensor into contact with the connector at a plurality of positions in advance, the plurality of pieces of tactile data on the insertion target being acquired by bringing the tactile sensor into contact with the insertion target at the plurality of positions in advance.

(13)

An information processing method including:
acquiring a first sensor value by bringing a tactile sensor into contact with a connector;
acquiring a second sensor value by bringing the tactile sensor into contact with a first candidate location of an insertion target for the connector; and
predicting a positional deviation amount between the connector and the insertion target on the basis of the first sensor value and the second sensor value.

The present application claims the benefit of Japanese Priority Patent Application JP2021-115815 filed with the Japan Patent Office on Jul. 13, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An information processor comprising a deviation amount predictor that predicts, on a basis of a first sensor value acquired by bringing a tactile sensor into contact with a connector and a second sensor value acquired by bringing the tactile sensor into contact with a first candidate location of an insertion target for the connector, a positional deviation amount between the connector and the insertion target.

2. The information processor according to claim 1, further comprising a position control unit that corrects a position of the connector on a basis of the positional deviation amount predicted by the deviation amount predictor.

3. The information processor according to claim 2, wherein the position control unit causes a robot gripping the connector to correct the position of the connector.

4. The information processor according to claim 1, further comprising an insertion target detector that detects a region corresponding to the connector in the first candidate location on a basis of the first sensor value and the second sensor value to calculate a degree of certainty as to with what degree of probability the region corresponding to the connector corresponds to the connector.

5. The information processor according to claim 4, further comprising a contact control unit that brings the tactile sensor into re-contact with a second candidate location that differs from the first candidate location in a case where the degree of certainty calculated by the insertion target detector is lower than a first threshold value.

6. The information processor according to claim 5, wherein the contact control unit determines the second candidate location on a basis of the degree of certainty in a case where the degree of certainty is lower than the first threshold value and is higher than a second threshold value.

7. The information processor according to claim 5, wherein the contact control unit designates any given region that differs from the first candidate location as the second candidate location in a case where the degree of certainty is lower than the first threshold value and is lower than a second threshold value.

8. The information processor according to claim 4, wherein the insertion target detector detects, in a case where there is a plurality of regions corresponding to the connector, a region where the degree of certainty is highest among the plurality of regions, as the insertion target for the connector.

9. The information processor according to claim 4, wherein the insertion target detector performs learning for detecting the region corresponding to the connector on a basis of tactile data on the connector and tactile data on the insertion target, the tactile data on the connector being acquired by bringing the tactile sensor into contact with the connector at a reference position in advance, the tactile data on the insertion target being acquired by bringing the tactile sensor into contact with the insertion target at the reference position in advance.

10. The information processor according to claim 4, wherein the insertion target detector performs learning for detecting the region corresponding to the connector on a basis of a plurality of pieces of tactile data on the connector and a plurality of pieces of tactile data on the insertion target, the plurality of pieces of tactile data on the connector being acquired by bringing the tactile sensor into contact with the connector at a plurality of positions in advance, the plurality of pieces of tactile data on the insertion target being acquired by bringing the tactile sensor into contact with the insertion target at the plurality of positions in advance.

11. The information processor according to claim 10, wherein
the plurality of pieces of tactile data on the connector is each provided with additional information regarding a location with which the connector has actually come into contact, and
the plurality of pieces of tactile data on the insertion target is each provided with additional information regarding a location with which the insertion target has actually come into contact.

12. The information processor according to claim 1, wherein the deviation amount predictor performs learning for predicting the positional deviation amount on a basis of a plurality of pieces of tactile data on the connector and a plurality of pieces of tactile data on the insertion target, the plurality of pieces of tactile data on the connector being acquired by bringing the tactile sensor into contact with the connector at a plurality of positions in advance, the plurality of pieces of tactile data on the insertion target being acquired by bringing the tactile sensor into contact with the insertion target at the plurality of positions in advance.

13. An information processing method comprising:
acquiring a first sensor value by bringing a tactile sensor into contact with a connector,
acquiring a second sensor value by bringing the tactile sensor into contact with a first candidate location of an insertion target for the connector; and
predicting a positional deviation amount between the connector and the insertion target on a basis of the first sensor value and the second sensor value.
